(19) United States
(12) Patent Application Publication
(10) Pub. No.: US 2024/0236659 A1
(43) Pub. Date: Jul. 11, 2024

(54) SYSTEMS AND METHODS FOR ENHANCING EFFICIENCY IN CALL DISTRIBUTION

(71) Applicant: Fortinet, Inc., Sunnyvale, CA (US)

(72) Inventor: PABLO MOLINERO FERNANDEZ, Madrid (ES)

(73) Assignee: Fortinet, Inc., Sunnyvale, CA (US)

(21) Appl. No.: 18/093,677

(22) Filed: Jan. 5, 2023

(51) Int. Cl. H04W 12/03

(52) U.S. Cl. CPC H04W 12/03; H04M 3/523

(57) ABSTRACT

Various approaches for call distribution in a communication network are discussed. In some embodiments, systems and methods for enhancing call distribution efficiency are discussed that include selective encryption application.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright @ 2021, Fortinet, Inc.

### FIELD

Embodiments disclosed herein generally relate to distribution of calls across a communication network, and more particularly to systems and methods for enhancing call distribution efficiency by selectively applying encryption.

### BACKGROUND

Cellular communications transmit via various network elements with each of the network elements applying some level of processing to the communications traversing the respective network element. In some cases, the processing applied by one network element is duplicative to that applied by another network element resulting in network inefficiencies. Such inefficiencies are accepted in part because different network elements are provided by different suppliers and there is often little incentive to reduce the inefficiencies.

Thus, there exists a need in the art for more advanced approaches, devices and systems for efficiently transmitting communications in a network environment.

### SUMMARY

Various embodiments provide systems and methods for enhancing call distribution efficiency by selectively applying encryption.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1C illustrate a network architecture including a cell processing server and a radio access network device one or more of which include selective communication encryption capability in accordance with some embodiments;

FIG. 2 is a flow diagram showing a method in accordance with some embodiments for selectively encrypting communications;

FIG. 3 is a flow diagram showing another method in accordance with other embodiments for selectively encrypting communications;

FIG. 4 is a flow diagram showing yet another method in accordance with yet other embodiments for selectively encrypting communications using a hardware accelerator; and

FIG. 5 depicts example packet header maps for both encrypted and unencrypted communications that may be used in relation to some embodiments.

### DETAILED DESCRIPTION

Various embodiments provide systems and methods for enhancing call distribution efficiency by selectively applying encryption.

It has been estimated that user-plane traffic is doubling every twenty-four (24) months, and this will increase as networks fully transform to higher bandwidth 5G technology. It has been found that greater than ninety (90) percent of the aforementioned user-plane traffic is in the downstream direction. For purposes of this document, the downstream direction is from a network device moving toward a user equipment, and an upstream direction is from a network device moving away from the user equipment. It has further been found that most of the aforementioned user-plane traffic is encrypted end-to-end (more than seventy-five (75) percent). As such, applying additional encryption at points between the endpoints does not add much security beyond what has already been achieved by the end-to-end encryption.

Some embodiments discussed herein provide systems and methods for selectively encrypting network traffic based in part on one or more of: (a) the direction of network traffic, (b) prior encryption of network traffic, and/or (c) complexity of determining a type of network traffic. In some cases, only downstream network traffic is selectively processed to determine applicability of selective encryption processing. In other cases, both downstream and upstream network traffic is selectively processed to determine applicability of selective encryption processing. In various cases, only network traffic exhibiting an expected header length is selectively processed to determine applicability of selective encryption processing. In other cases, network traffic exhibiting headers of multiple lengths is selectively processed to determine applicability of selective encryption processing.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”. “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrase “processing resource” is used in its broadest sense to mean one or more processors capable of executing instructions.

Some embodiments provide methods for efficiently transferring network communications. The methods include: receiving, by a first processing device, a directional network packet; determining, by the first processing device, whether the directional network packet is previously encrypted; when it is determined that the directional network packet was not previously encrypted: encrypting, by the first processing device, the directional network packet to yield a newly encrypted network packet; and transmitting, by the first processing device, the newly encrypted network packet toward a second processing device; and when it is determined that the directional network packet was previously encrypted: transmitting, by the first processing device, the directional network packet toward the second processing device.

In some instances of the aforementioned embodiment, the directional network packet is a downstream network packet, and wherein the first processing device is a call processing server and the second processing device is a radio access network device. In some such instances where the newly encrypted network packet is a first newly encrypted network packet, the methods further include: receiving, by the radio access network device, an upstream network packet; determining, by radio access network device, whether the upstream network packet is previously encrypted; when it is determined that the upstream network packet was not previously encrypted: encrypting, by the radio access network device, the upstream network packet to yield a second newly encrypted network packet; and transmitting, by the radio access network device, the second newly encrypted network packet toward the call processing server; and when it is determined that the upstream network packet was previously encrypted: transmitting, by the radio access network device, the upstream network packet toward the call processing server.

In other such instances, the processing server includes an application specific semiconductor device configured to: (a) determine whether the downstream network packet is previously encrypted, (b) selectively encrypt the downstream network packet based at least in part on the determination that the downstream network packet is previously encrypted. In yet other such instances, the call processing server includes a processing resource and a non-transient computer readable medium, wherein the non-transient computer readable medium includes instructions executable by the processing resource to: (a) determine whether the downstream network packet is previously encrypted, (b) selectively encrypt the downstream network packet based at least in part on the determination that the downstream network packet is previously encrypted.

In various instances of the aforementioned embodiments, the directional network packet is an upstream network packet, and wherein the first processing device is a radio access network device and the second processing device is a call processing server. In some instances of the aforementioned embodiments, the methods further include: determining, by the first processing device, whether the directional network packet includes a header of an expected length. In such instances, transmitting the directional network packet toward the second processing device is done when both the header is of the expected length and it is determined that the directional network packet was previously encrypted. In further instances of the aforementioned embodiments, determining whether the directional network packet includes a header of an expected length includes interrogating a GTP-U field of a header of the directional network packet, and/or determining whether the directional network packet is previously encrypted includes: interrogating a TCP or UDP field of a header of the directional network packet.

Other embodiments provide systems for efficiently transferring network communications that include a first processing device. The first processing device is configured to: receive a directional network packet; determine whether the directional network packet is previously encrypted; when it is determined that the directional network packet was not previously encrypted: encrypt the directional network packet to yield a newly encrypted network packet; and transmit the newly encrypted network packet toward a second processing device; and when it is determined that the directional network packet was previously encrypted: transmit the directional network packet toward the second processing device.

Yet other embodiments provide a non-transient computer readable medium included as part of a first processing device and having stored therein instructions that when executed by a processing resource cause the processing resource to: receive a directional network packet; determine whether the directional network packet is previously encrypted; when it is determined that the directional network packet was not previously encrypted: encrypt the directional network packet to yield a newly encrypted network packet; and transmit the newly encrypted network packet toward a second processing device; and when it is determined that the directional network packet was previously encrypted: transmit the directional network packet toward the second processing device.

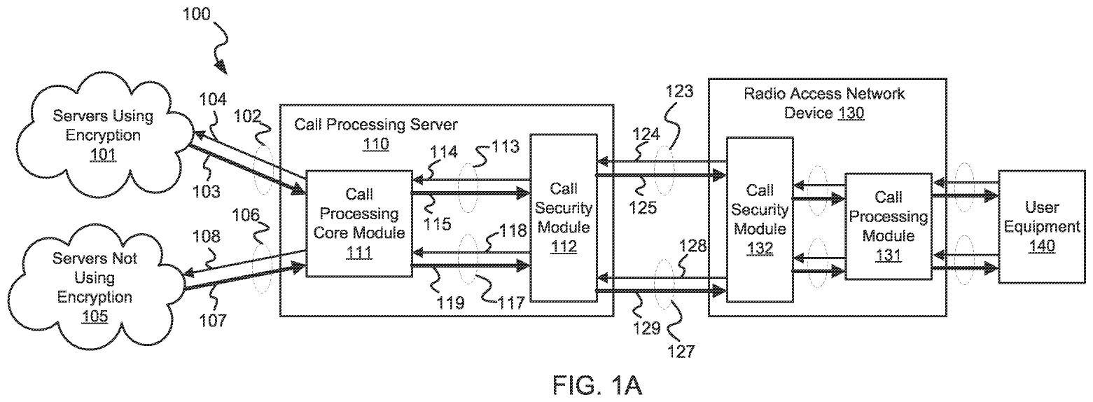

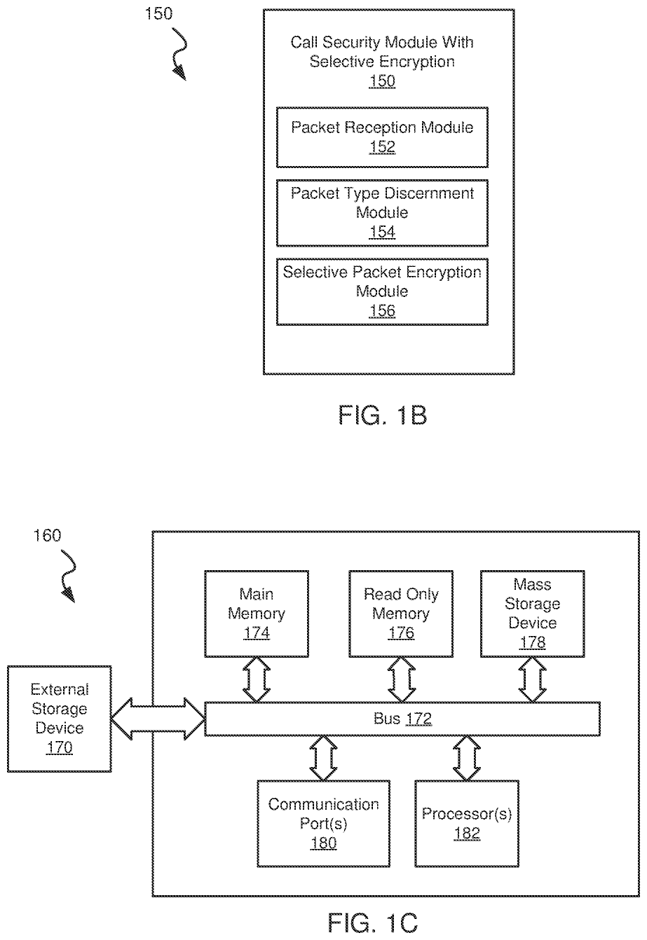

Turning to FIG. 1A, network architecture 100 is shown in accordance with some embodiments that includes a call processing server 110 and a radio access network device 130. One or more of a call processing server 110 and/or radio access network device 130 include selective communication encryption capability in accordance with some embodiments. As shown, call processing server 110 includes a Call processing core module 111 that may be any circuitry known in the art for receiving network traffic that includes radio transmitted data. In some instances, Call processing core module 111 includes all circuitry needed to process and/or retransmit 5G communications. In some cases, network traffic 102 including radio transmission data that is received from and sent to servers using encryption 101; and network traffic 106 including radio transmission data is received from and sent to servers not using encryption 105. Network traffic 102 includes downstream traffic 103 and upstream traffic 104; and network traffic 106 includes downstream traffic 107 and upstream traffic 108.

Servers using encryption 101 may be any network device(s) capable of receiving and transmitting network communications where the respective network device applies encryption to downstream communications. Similarly, servers using encryption 105 may be any network device(s) capable of receiving and transmitting network communications where the respective network device does not apply encryption to downstream communications.

Call processing core module 111 forwards both network traffic 102 and network traffic 106 to/from a call security module 112. In particular, network traffic 102 is transferred to/from call security module 112 as encrypted network traffic 113 including downstream network traffic 115 and upstream network traffic 114; and network traffic 106 is transferred to/from call security module 112 as un-encrypted network traffic 117 including downstream network traffic 119 and upstream network traffic 118.

Call security module 112 selectively encrypts downstream network traffic 115 and downstream network traffic 119. In cases where none of downstream network traffic 115 or downstream network traffic 119 are selected for encryption both downstream network traffic 115 and downstream network traffic 119 are provided to radio access network device 130 as downstream network traffic 129 that is included with upstream network traffic 128 in un-encrypted network traffic 127. Un-encrypted network traffic 127 does not use additional IPSec tunnels created to transfer network traffic between call processing server 110 and radio access network device 130. In this case, any encryption that was previously applied by servers using encryption 101 remains, but the upstream traffic is not moved using additional IPSec tunnels created to transfer network traffic 123 including upstream traffic 125 and downstream traffic 124.

In other cases where downstream network traffic 119 is selected for encryption, downstream network traffic 119 is encrypted and provided to radio access network device 130 as downstream network traffic 125. Network traffic 123 uses IPSec tunnels created to transfer network traffic between call processing server 110 and radio access network device 130. In yet other cases, some or all of downstream network traffic 119 and some or all of downstream network traffic 115 are selected for additional encryption. In such cases, encrypted portions of downstream network traffic 115 and downstream network traffic 119 are encrypted and transferred to radio access network device 130 as downstream network traffic 125; and non-encrypted portions of downstream network traffic 115 and downstream network traffic 119 (i.e., portions of downstream network traffic 115 that are not additionally encrypted by call security module 112 and/or portions of downstream network traffic 119 that are not encrypted) are transferred to radio access network device 130 as downstream network traffic 129.

Where it is assumed that seventy-five (75) percent of all downstream network traffic derives from servers using encryption 101 and that of all network traffic ninety (90) percent is downstream network traffic, applying selective encryption by call security module 112 where encryption is applied to only downstream network traffic derived from servers not using encryption 105 (i.e., twenty-five (25) percent of all downstream network traffic) results in a reduction of 67.5% of all encryption to be applied by call processing server 110 and radio access network device 130. This considerable reduction in encryption does not appreciably reduce overall security, and yet alleviates the need for added processing capability to cope with increasing network bandwidth demands.

A call security module 132 of radio access network device 130 receives both downstream network traffic 125 and downstream network traffic 129, and passes downstream network traffic 125 to a call processing module 131, and in turn call processing module 131 processes the respective network traffic and provides it to a user equipment 140. User equipment 140 may be any user equipment known in the art that is capable of receiving and/or transmitting radio frequency network communications. As one example, user equipment 140 is a mobile phone. Based upon the disclosure provided herein, one of ordinary skill in the art will recognize a variety of devices that may be used as user equipment 140.

Radio access network device 130 may be any device capable of receiving and/or transmitting radio frequency network communications, and processing network traffic to/from a call processing server. In some embodiments, radio access network device 130 is a prior art radio access network device that encrypts all communications to call processing server 110. In such a case, all upstream communications from radio access network device 130 to call processing server 110 are encrypted by call security module 132. This results in additional encryption being applied to network traffic received from user equipment 140 where user equipment 140 that already provides encryption, and will result in encryption being applied to network traffic received from user equipment 140 where user equipment 140 does not provide encryption. In such a situation where only downstream network traffic is selectively encrypted by call security module 112 and all upstream network traffic is encrypted (i.e., selective encryption is not supported) by call security module 132, a considerable reduction in resources used for encryption is still achieved because such a large percentage (e.g., ninety (90) percent) of the overall network traffic is downstream network traffic.

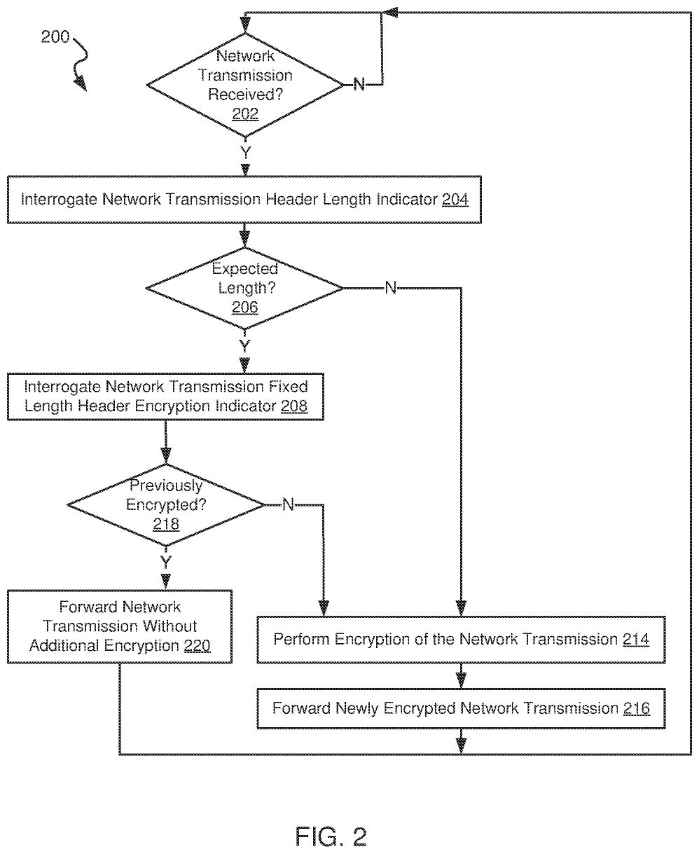

In some embodiments, call security module 132 of radio access network device 130 is configured to support selective encryption. Such selective encryption works the same as that discussed above in relation to call security module 112, except that the selective encryption is applied to the upstream network traffic. As an example, where all previously un-encrypted upstream network traffic from user equipment 140 is selected for encryption and all other network traffic is not selected for encryption because it was previously encrypted by user equipment 140, call security module 132 encrypts (at the network level) the previously un-encrypted (i.e., not encrypted at the network level) upstream network traffic and provides to call processing server 110 as upstream network traffic 124, and provides the previously encrypted upstream network traffic to call processing server 110 as upstream network traffic 128. Building on the example above where it is assumed that seventy-five (75) percent of all downstream network traffic derives from servers using encryption 101 and that of all network traffic ninety (90) percent is downstream network traffic, and it is additionally assumed that seventy-five (75) percent of all upstream network traffic derives from user equipment 140 that applies encryption, an additional reduction of 7.5% of all encryption to be applied by call processing server 110 and radio access network device 130 can be eliminated. Thus, where both call security module 112 applies selective encryption to downstream network traffic and call security module 132 applies selective encryption of upstream network traffic, a total reduction of seventy-five (75) percent (or more where the assumptions are different) of all encryption to be applied by call processing server 110 and radio access network device 130 is possible. Based upon the disclosure provided herein, one of ordinary skill in the art will recognize other achievable savings depending upon the particular network traffic assumptions and implementations of selectivity as more fully described below in relation to FIGS. 2-4.

Turning to FIG. 1B, an example implementation of call security module with selective encryption 150 is shown in accordance with some embodiments. Call security module with selective encryption 150 may be used for one or both of call security module 112 where selective encryption is applied to downstream network traffic and/or call security module 132 where selective encryption is applied to upstream network traffic. As shown in this example, call security module with selective encryption 150 includes a packet reception module 152, a packet type discernment module 154, and a selective packet encryption module 156.

Packet reception module 152 is configured to receive network packets from either an upstream device or a downstream device. Packet type discernment module 154 is configured to interrogate a header included as part of a received network packet to discern if: (a) the header of the received network packet is of an expected length, and (b) whether the received network packet was previously encrypted. Selective packet encryption module 156 is configured to selectively encrypt the received network packet based at least in part on one or both of the determination of whether the header of the network packet is an expected length, and/or the of whether the received network packet was previously encrypted.

In some embodiments, packet reception module 152, packet type discernment module 154, and selective packet encryption module 156 are implemented as instructions executable by a processing resource to perform the respective processes discussed above. In other embodiments, packet reception module 152, packet type discernment module 154, and selective packet encryption module 156 are implemented together in an application specific semiconductor (ASIC) device. In yet other embodiments, a subset of the combination of packet reception module 152, packet type discernment module 154, and selective packet encryption module 156 is implemented as instructions executable by a processing resource, and another subset of the combination of packet reception module 152, packet type discernment module 154, and selective packet encryption module 156 is implemented together in an ASIC device.

Turning to FIG. 1C, an example computer system 160 in which or with which embodiments of the present invention may be utilized is shown. In some case, one or more of node 104a or node 104b may be implemented to include the features of example computer system 160. As shown in FIG. 1C, computer system 160 includes an external storage device 170, a bus 172, a main memory 174, a read-only memory 176, a mass storage device 178, a communication port 180, and one or more processors 182.

Those skilled in the art will appreciate that computer system 160 may include more than one processor 182 and communication ports 180. Examples of processor 182 include, but are not limited to, an Intel® Itanium®, Intel® Xeon® processor, or AMD® Opteron® or Athlon MP® processor(s). Motorola® lines of processors, FortiSOC™ system on chip processors or other future processors. Processor 182 may include various modules associated with embodiments of the present invention.

Communication port 180 can be any of an RS-232 port for use with a modem-based dialup connection, a 10/100 Ethernet port, a Gigabit or 10 Gigabit port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read-Only Memory 176 can be any static storage device(s) e.g., but not limited to, a Programmable Read-Only Memory (PROM) chips for storing static information e.g. start-up or BIOS instructions for processor 182.

Mass storage 178 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs. Redundant Array of Independent Disks (RAID) storage. e.g. an array of disks (e.g., SATA arrays), available from various vendors including Dot Hill Systems Corp., LaCie, Nexsan Technologies, Inc. and Enhance Technology, Inc.

Bus 172 communicatively couples processor(s) 182 with the other memory, storage, and communication blocks. Bus 172 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 182 to a software system.

Optionally, operator and administrative interfaces, e.g. a display, keyboard, and a cursor control device, may also be coupled to bus 172 to support direct operator interaction with the computer system. Other operator and administrative interfaces can be provided through network connections connected through communication port 180. An external storage device 170 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned example computer system limit the scope of the present disclosure.

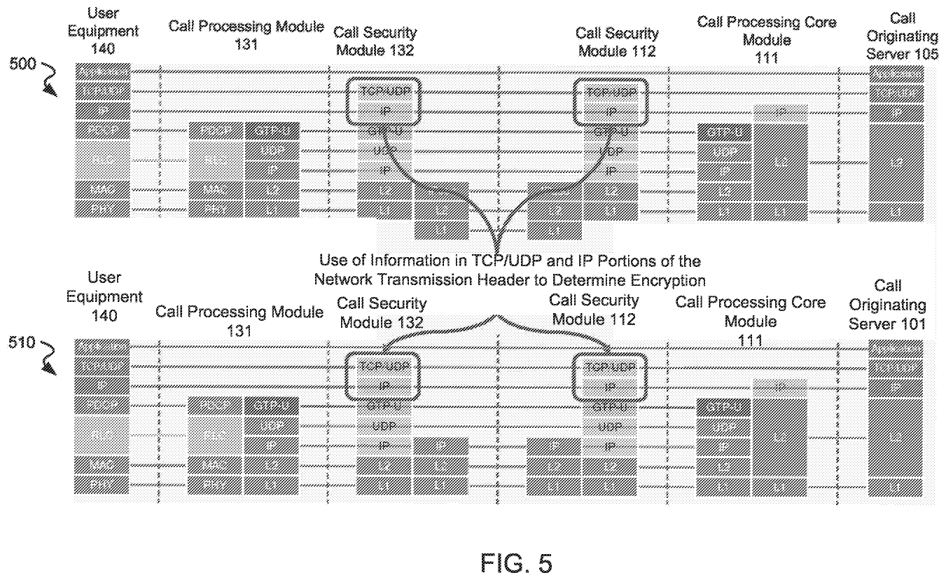

Turning to FIG. 2, a flow diagram 200 shows a method in accordance with some embodiments for selectively encrypting communications. Following flow diagram 200, it is determined whether a network packet has been received (block 202). In the case of a call processing module in a call processing server, it is determined whether a downstream network packet has been received. In contrast, in the cases of a call processing module in a radio access network device, it is determined whether an upstream network packet has been received. Such network packets include both header information and payload data as is known in the art, and may or may not have been encrypted prior to reception. Network packets that were encrypted prior to reception are referred to as encrypted network packets, and those not encrypted prior to reception are referred to as un-encrypted network packets.

Where a network packet has been received (block 202), the header information included as part of the network packet is interrogated to determine whether the header length is an expected header length or another variable header length (block 204). Turning to FIG. 5, an example header 500 for an encrypted network packet(flow 123) and an example header 510 for an un-encrypted network packet (flow 127) are shown. As shown, in both header 500 and header 510 a GTP-U field includes an indication of the length of the header. Thus, for network packets received by a call processing module in a call processing server, the GTP-U field of call processing module 111 is interrogated, and for network packets received by a call processing module in a radio access network device, the GTP-U field of call processing module 131 is interrogated. For an IPv4 network packet, the most common header length is twenty (20) bytes and is indicated where: (a) either an ‘S’ or ‘SN’ flag is a logic ‘0’, and (b) an ‘E’ flag is a logic ‘1’. For an IPv6 network packet, the most common header length is twenty (40) bytes and is indicated where: (a) either the ‘S’ or ‘SN’ flag is a logic ‘O’, and (b) the ‘E’ flag is a logic ‘1’. Returning to FIG. 2, the expected length is forty (40) bytes for IPV6 network packets and twenty (20) bytes for IPV4 network packets. Any process for extracting information from the relevant GTP-U field may be used as part of interrogating the received network packet to determine if the header length of the network packet is the expected length.

It is determined if the header for the received network packet is an expected length (block 206). The expected length may be user selectable, and as discussed above, in some embodiments the expected header length is forty (40) bytes for IPV6 network packets and twenty (20) bytes for IPV4 network packets. Where the header length is not the expected header length (block 206), the received network packet is encrypted regardless of whether it was previously encrypted (block 214) and the newly encrypted network packet is forwarded (block 216). As such, a network packet with a header of a length other than what is expected may be encrypted only once where the received network packet was not previously encrypted, and will be additionally encrypted where the received network packet was previously encrypted. The wasted additional encryption is acceptable where the processing required to interrogate a header that is other than an expected length requires more than what would be required to add the additional encryption to network packets that were previously encrypted. This may be particularly true where call security modules are implemented in ASICs where the complexity of the ASIC design may be substantially reduced by ignoring anything other than network packets with headers of an expected length.

Alternatively, where the received network packet has a header of the expected length (block 206), the fixed length header of the network packet is interrogated to determine whether the network packet was previously encrypted (block 208). Turning to FIG. 5, the internal TCP/UDP header identified for both header 500 and header 510 is accessed to determine whether the received network packet is encrypted. Thus, for network packets received by a call processing module in a call processing server, the TCP/UDP field of call security module 112 is interrogated where it has the port number in the downstream direction at the 0 bits position, and for network packets received by a call processing module in a radio access network device, the TCP/UDP field of call processing module 132 is interrogated where it has the port number in the upstream direction at the sixteen (1) bits position. In some embodiments, where the port number in the respective one of the aforementioned bits position is any of ‘443’, ‘465’, 853′, ‘990’, ‘993’, or ‘995’ for transport layer security (“TLS”) communications security, or ‘22’ for secured shell (“SSH”) communications security, the received network packet is identified as previously encrypted. Otherwise, the received network packet is identified as previously un-encrypted at the network level.

It is determined whether the received network packet was previously encrypted (block 218). As mentioned above, in some embodiments this may be done by comparing the TCP/UDP field with a number of port numbers identified as indicating encryption. Where the received network packet has not been previously encrypted (block 218), the received network packet is encrypted (block 214) and the newly encrypted network packet is forwarded (block 216). As such, a previously un-encrypted network packet is encrypted before being forwarded.

Where, on the other hand, it is determined that the received network packet has already been encrypted (block 218), the received network packet is forwarded without additional encryption (block 220). Considerable communications transmission may be achieved by avoiding adding additional encryption to previously encrypted network packets.

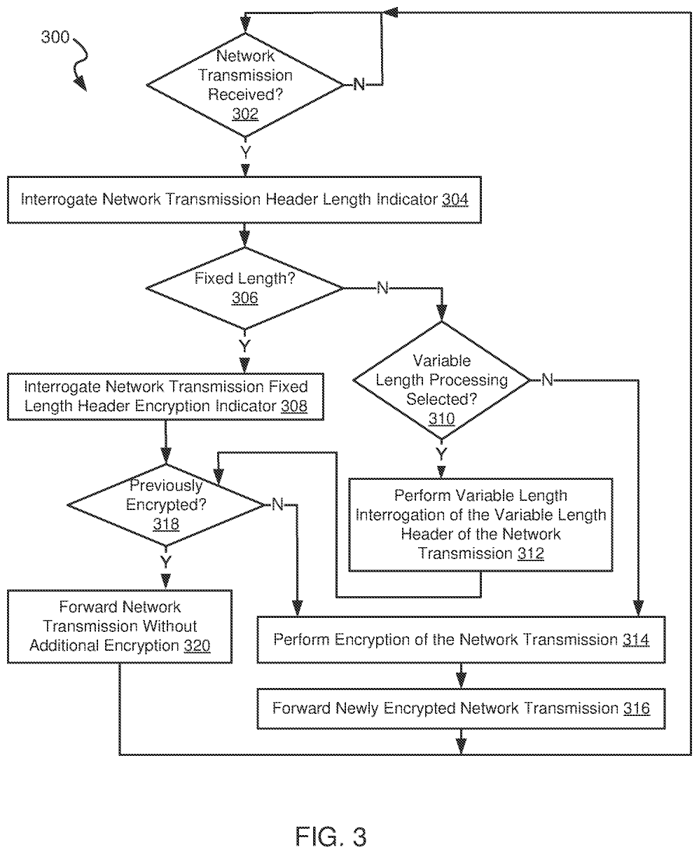

Turning to FIG. 3, a flow diagram 300 shows another method in accordance with other embodiments for selectively encrypting communications. Following flow diagram 300, it is determined whether a network packet has been received (block 302). In the case of a call processing module in a call processing server, it is determined whether a downstream network packet has been received. In contrast, in the cases of a call processing module in a radio access network device, it is determined whether an upstream network packet has been received. Such network packets include both header information and payload data as is known in the art, and may or may not have been encrypted prior to reception. Network packets that were encrypted prior to reception are referred to as encrypted network packets, and those not encrypted prior to reception are referred to as un-encrypted network packets.

Where a network packet has been received (block 302), the header information included as part of the network packet is interrogated to determine whether the header length is an expected header length or another variable header length (block 204). Turning to FIG. 5, in both header 500 and header 510 a GTP-U field includes an indication of the length of the header. Thus, for network packets received by a call processing module in a call processing server, the GTP-U field of call processing module 111 is interrogated, and for network packets received by a call processing module in a radio access network device, the GTP-U field of call processing module 131 is interrogated. For an IPv4 network packet, the most common header length is twenty (20) bytes and is indicated where: (a) either an ‘S’ or ‘SN’ flag is a logic ‘0’, and (b) an ‘E’ flag is a logic ‘1’. For an IPv6 network packet, the most common header length is twenty (40) bytes and is indicated where: (a) either the ‘S’ or ‘SN’ flag is a logic ‘0’, and (b) the ‘E’ flag is a logic ‘I’. Returning to FIG. 2, the expected length is forty (40) bytes for IPV6 network packets and twenty (20) bytes for IPV4 network packets. Any process for extracting information from the relevant GTP-U field may be used as part of interrogating the received network packet to determine if the header length of the network packet is the expected length.

It is determined if the header for the received network packet is an expected length (block 306). The expected length may be user selectable, and as discussed above, in some embodiments the expected header length is forty (40) bytes for IPV6 network packets and twenty (20) bytes for IPv4 network packets. Where the received network packet has a header of the expected length (block 306), the fixed length header of the network packet is interrogated to determine whether the network packet was previously encrypted (block 308). Turning to FIG. 5, the internal TCP/UDP header identified for both header 500 and header 510 is accessed to determine whether the received network packet is encrypted. Thus, for network packets received by a call processing module in a call processing server, the TCP/UDP field of call security module 112 is interrogated where it has the port number in the downstream direction at the 0 bits position, and for network packets received by a call processing module in a radio access network device, the TCP/UDP field of call processing module 132 is interrogated is interrogated where it has the port number in the upstream direction at the sixteen (1) bits position. In some embodiments, where the port number in the respective one of the aforementioned bits position is any of ‘443’, ‘465’, 853′, ‘990’, ‘993’, or ‘995’ for TLS communications security, or ‘22’ for SSH communications security, the received network packet is identified as previously encrypted. Otherwise, the received network packet is identified as previously un-encrypted.

It is determined whether the received network packet was previously encrypted (block 318). As mentioned above, in some embodiments this may be done by comparing the TCP/UDP field with a number of port numbers identified as indicating encryption. Where the received network packet has not been previously encrypted (block 318), the received network packet is encrypted (block 314) and the newly encrypted network packet is forwarded (block 316). As such, a previously un-encrypted network packet is encrypted before being forwarded.

Where, on the other hand, it is determined that the received network packet has already been encrypted (block 318), the received network packet is forwarded without additional encryption (block 320). Considerable communications transmission may be achieved by avoiding adding additional encryption to previously encrypted network packets.

Where, in contrast, the header length is not the expected header length (block 306), it is determined whether a user programmable input of variable length header processing has been set such that variable length header processing is to be performed (block 310). Where variable length header processing is not to be performed (block 310), the received network packet is encrypted regardless of whether it was previously encrypted (block 314) and the newly encrypted network packet is forwarded (block 316). As such, a network packet with a header of a length other than what is expected and where variable length header processing is not selected may be encrypted only once where the received network packet was not previously encrypted, and will be additionally encrypted where the received network packet was previously encrypted.

Alternatively, where the header length is not the expected header length (block 306) and variable length header processing is selected (block 310), interrogation of the variable length header is performed to identify whether the network packet was previously encrypted (block 312). Such interrogation relies upon the same TCP/UDP field discussed above in relation to block 308, however, the location of the field is not in the same fixed position as occurs where the header length is the expected length. As such, the length of the header must be determined and the location of the TCP/UDP field calculated based upon the determined length of the header. This requires additional processing to that required where the TCP/UDP field can be expected in a known position in a header of an expected length.

After the variable length header has been interrogated (block 312), it is determined whether the received network packet was previously encrypted (block 318). Where the received network packet has not been previously encrypted (block 318), the received network packet is encrypted (block 314) and the newly encrypted network packet is forwarded (block 316). As such, a previously un-encrypted network packet is encrypted before being forwarded.

Where, on the other hand, it is determined that the received network packet has already been encrypted (block 318), the received network packet is forwarded without additional encryption (block 320). Considerable communications transmission may be achieved by avoiding adding additional encryption to previously encrypted network packets.

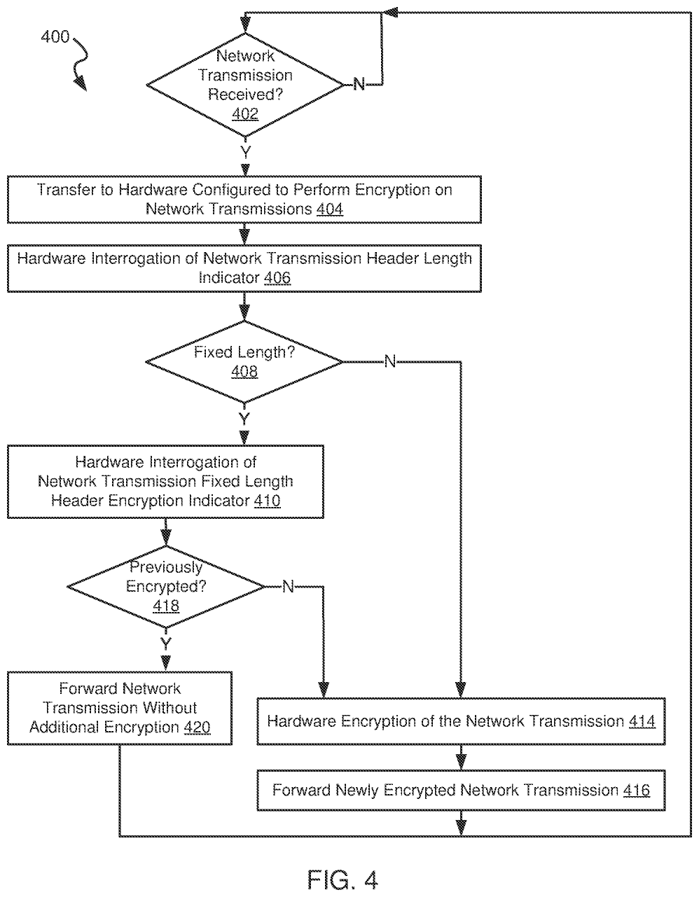

FIG. 4 is a flow diagram showing yet another method in accordance with yet other embodiments for selectively encrypting communications using a hardware accelerator. Following flow diagram 400, it is determined whether a network packet has been received (block 402). In the case of a call processing module in a call processing server, it is determined whether a downstream network packet has been received. In contrast, in the cases of a call processing module in a radio access network device, it is determined whether an upstream network packet has been received. Such network packets include both header information and payload data as is known in the art, and may or may not have been encrypted prior to reception. Network packets that were encrypted prior to reception are referred to as encrypted network packets, and those not encrypted prior to reception are referred to as un-encrypted network packets.

Where a network packet has been received (block 402), the network packet is transferred to a hardware accelerator device for header processing (block 404). In some embodiments, the hardware acceleration device may be an ASIC specifically tailored for header interrogation and encryption of network packets. The hardware acceleration device performs interrogation of the header of the received network packet to identify the header length indicator (block 406). Turning to FIG. 5, header 500 and header 510 a GTP-U field includes an indication of the length of the header. Thus, for network packets received by a call processing module in a call processing server, the GTP-U field of call processing module 111 is interrogated, and for network packets received by a call processing module in a radio access network device, the GTP-U field of call processing module 131 is interrogated. For an IPv4 network packet, the most common header length is twenty (20) bytes and is indicated where: (a) either an ‘S’ or ‘SN’ flag is a logic ‘0’, and (b) an ‘E’ flag is a logic ‘1’. For an IPV6 network packet, the most common header length is twenty (40) bytes and is indicated where: (a) either the ‘S’ or ‘SN’ flag is a logic ‘0’, and (b) the ‘E’ flag is a logic ‘1’. Returning to FIG. 4, the expected length is forty (40) bytes for IPv6 network packets and twenty (20) bytes for IPV4 network packets. Any process for extracting information from the relevant GTP-U field may be used as part of interrogating the received network packet to determine if the header length of the network packet is the expected length.

It is determined if the header for the received network packet is an expected length (block 408). The expected length may be user selectable, and as discussed above, in some embodiments the expected header length is forty (40) bytes for IPV6 network packets and twenty (20) bytes for IPv4 network packets. Where the header length is not the expected header length (block 408), the hardware accelerator device encrypts the received network packet regardless of whether it was previously encrypted (block 414) and the newly encrypted network packet is forwarded (block 416).

Alternatively, where the received network packet has a header of the expected length (block 408), the fixed length header of the network packet is interrogated by the hardware accelerator to determine whether the network packet was previously encrypted (block 410). Turning to FIG. 5, the internal TCP/UDP header identified for both header 500 and header 510 is accessed to determine whether the received network packet is encrypted. Thus, for network packets received by a call processing module in a call processing server, the TCP/UDP field of call security module 112 is interrogated where it has the port number in the downstream direction at the 0 bits position, and for network packets received by a call processing module in a radio access network device, the TCP/UDP field of call processing module 132 is interrogated is interrogated where it has the port number in the upstream direction at the sixteen (1) bits position. In some embodiments, where the port number in the respective one of the aforementioned bits position is any of ‘443’, ‘465’, 853′, ‘990’, ‘993’, or ‘995’ for transport layer security (“TLS”) communications security, or ‘22’ for secured shell (“SSH”) communications security, the received network packet is identified as previously encrypted. Otherwise, the received network packet is identified as previously un-encrypted.

It is determined whether the received network packet was previously encrypted (block 418). As mentioned above, in some embodiments this may be done by comparing the TCP/UDP field with a number of port numbers identified as indicating encryption. Where the received network packet has not been previously encrypted (block 418), the received network packet is encrypted (block 414) and the newly encrypted network packet is forwarded (block 416). As such, a previously un-encrypted network packet is encrypted before being forwarded.

Where, on the other hand, it is determined that the received network packet has already been encrypted (block 418), the received network packet is forwarded without additional encryption (block 420). Considerable communications transmission may be achieved by avoiding adding additional encryption to previously encrypted network packets.

In conclusion, embodiments discussed herein provide novel systems, devices, and methods. While detailed descriptions of one or more embodiments have been given above, various alternatives, modifications, and equivalents will be apparent to those skilled in the art without varying from the spirit of the claims. Therefore, the above description should not be taken as limiting the scope of the inventions, which are defined by the appended claims.

What is claimed is:

1. A method for efficiently transferring network communications, the method comprising:
receiving, by a first processing device, a directional network packet;
determining, by the first processing device, whether the directional network packet is previously encrypted;
when it is determined that the directional network packet was not previously encrypted:
encrypting, by the first processing device, the directional network packet to yield a newly encrypted network packet; and
transmitting, by the first processing device, the newly encrypted network packet toward a second processing device; and
when it is determined that the directional network packet was previously encrypted:
transmitting, by the first processing device, the directional network packet toward the second processing device.

2. The method of claim 1, wherein the directional network packet is a downstream network packet, and wherein the first processing device is a call processing server and the second processing device is a radio access network device.

3. The method of claim 2, wherein the newly encrypted network packet is a first newly encrypted network packet, the method further comprising:
receiving, by the radio access network device, an upstream network packet;
determining, by the radio access network device, whether the upstream network packet is previously encrypted;
when it is determined that the upstream network packet was not previously encrypted:
encrypting, by the radio access network device, the upstream network packet to yield a second newly encrypted network packet; and
transmitting, by the radio access network device, the second newly encrypted network packet toward the call processing server; and
when it is determined that the upstream network packet was previously encrypted:
transmitting, by the radio access network device, the upstream network packet toward the call processing server.

4. The method of claim 2, wherein the call processing server includes an application specific semiconductor device configured to: (a) determine whether the downstream network packet is previously encrypted, (b) selectively encrypt the downstream network packet based at least in part on the determination that the downstream network packet is previously encrypted.

5. The method of claim 2, wherein the call processing server includes a processing resource and a non-transient computer readable medium, wherein the non-transient computer readable medium includes instructions executable by the processing resource to: (a) determine whether the downstream network packet is previously encrypted, (b) selectively encrypt the downstream network packet based at least in part on the determination that the downstream network packet is previously encrypted.

6. The method of claim 1, wherein the directional network packet is an upstream network packet, and wherein the first processing device is a radio access network device and the second processing device is a call processing server.

7. The method of claim 1, the method further comprising:
determining, by the first processing device, whether the directional network packet includes a header of an expected length; and
wherein transmitting the directional network packet toward the second processing device is done when both the header is of the expected length and it is determined that the directional network packet was previously encrypted.

8. The method of claim 1, wherein determining whether the directional network packet includes a header of an expected length includes: interrogating a GTP-U field of a header of the directional network packet.

9. The method of claim 1, wherein determining whether the directional network packet is previously encrypted includes: interrogating a TCP field of a header of the directional network packet or interrogating a UDP field of a header of the directional network packet

10. A system for efficiently transferring network communications, the system comprising:
a first processing device configured to:
receive a directional network packet;
determine whether the directional network packet is previously encrypted;
when it is determined that the directional network packet was not 6 previously encrypted:
encrypt the directional network packet to yield a newly encrypted network packet; and
transmit the newly encrypted network packet toward a second processing device; and
when it is determined that the directional network packet was previously 12 encrypted:
transmit the directional network packet toward the second processing device.

11. The system of claim 10, wherein the directional network packet is a downstream network packet, and wherein the first processing device is a call processing server and the second processing device is a radio access network device.

12. The system of claim 3, wherein the newly encrypted network packet is a first newly encrypted network packet, and wherein the system further includes:
the radio access network device, wherein the radio access network device is configured to:
receive an upstream network packet;
determine whether the upstream network packet is previously encrypted;
when it is determined that the upstream network packet was not previously encrypted:
encrypt the upstream network packet to yield a second newly encrypted network packet; and
transmit the second newly encrypted network packet toward the call processing server; and
when it is determined that the upstream network packet was previously encrypted:
transmit the upstream network packet toward the call processing 15 server.

13. The system of claim 12, wherein the call processing server includes an application specific semiconductor device configured to: (a) determine whether the downstream network packet is previously encrypted, (b) selectively encrypt the downstream network packet based at least in part on the determination that the downstream network packet is previously encrypted.

14. The system of claim 12, wherein the call processing server includes a processing resource and a non-transient computer readable medium, wherein the non-transient computer readable medium includes instructions executable by the processing resource to: (a) determine whether the downstream network packet is previously encrypted, (b) selectively encrypt the downstream network packet based at least in part on the determination that the downstream network packet is previously encrypted.

15. The system of claim 10, wherein the directional network packet is an upstream network packet, and wherein the first processing device is a radio access network device and the second processing device is a call processing server.

16. The system of claim 10, wherein the first processing device is further configured to:
determine whether the directional network packet includes a header of an expected length; and
wherein transmitting the directional network packet toward the second processing device is done when both the header is of the expected length and it is determined that the directional network packet was previously encrypted.

17. A non-transient computer readable medium included as part of a first processing device and having stored therein instructions that when executed by a processing resource cause the processing resource to:
receive a directional network packet;
determine whether the directional network packet is previously encrypted;
when it is determined that the directional network packet was not previously encrypted:
encrypt the directional network packet to yield a newly encrypted network packet; and
transmit the newly encrypted network packet toward a second processing device; and
when it is determined that the directional network packet was previously encrypted:
transmit the directional network packet toward the second processing device.

18. The non-transient computer readable medium of claim 17, wherein the directional network packet is a downstream network packet, and wherein the first processing device is a call processing server and the second processing device is a radio access network device.

19. The non-transient computer readable medium of claim 17, wherein the directional network packet is an upstream network packet, and wherein the first processing device is a radio access network device and the second processing device is a call processing server.

20. The non-transient computer readable medium of claim 17, wherein the non-transient computer readable medium further has stored therein instructions that when executed by a processing resource cause the processing resource to:
determine whether the directional network packet includes a header of an expected length; and
wherein transmitting the directional network packet toward the second processing device is done when both the header is of the expected length and it is determined that the directional network packet was previously encrypted.
